(19) United States
(12) Patent Application Publication
(10) Pub. No.: US 2025/0248898 A1
(43) Pub. Date: Aug. 7, 2025

(54) VIAL HOLDER

(71) Applicant: Vikas K. Pilly, Williamsville, NY (US)

(72) Inventor: Vikas K. Pilly, Williamsville, NY (US)

(21) Appl. No.: 19/041,289

(22) Filed: Jan. 30, 2025

Related U.S. Application Data
(60) Provisional application No. 63/549,030, filed on Feb. 2, 2024.

(51) Int. Cl. A61J 1/16; F16B 2/06; F16M 11/04

(52) U.S. Cl. CPC A61J 1/16; F16B 2/065; F16M 11/041; F16M 11/046; F16M 2200/027

(57) ABSTRACT

A vial holder comprising a wall panel with recesses for fastening, a vial receiving section, and a spring assembly with rods and springs operable via a handle, where the assembly transitions a support bar between open and closed positions. A bottom panel features a vial recess to secure a vial during use.

### CROSS-REFERENCE TO RELATED APPLICATIONS

This application claims priority to U.S. Provisional Patent Application having Ser. No. 63/549,030, filed on Feb. 2, 2024, the entire disclosure of which is hereby incorporated herein by reference.

### BACKGROUND

In the medical field, especially during surgical procedures, the withdrawal of medication from vials is a routine yet crucial task. This process, typically involving the manual handling of vials by medical personnel, poses various challenges including inefficiencies and potential hazards such as needle stick injuries. These hazards can be linked to the necessity of having an assistant hold the vial, which introduces additional complexity and increases the demand for personnel during procedures.

Traditionally, medical personnel have relied on manual methods to manage vials, requiring a supporting assistant to physically secure the vial while another healthcare worker administers the medication. This practice not only consumes valuable manpower but also elevates the risk of inadvertent needle sticks to the assisting personnel. Moreover, manual vial handling can disrupt workflow efficiency, potentially impacting the overall pace and effectiveness of medical procedures.

Existing solutions, such as makeshift vial securing methods or non-specialized holders, often lack the necessary structural integrity and ergonomics to adequately address these issues. Many of these prior art solutions do not provide stable vial support, leading to increased handling time and a greater chance of needle-related incidents. Furthermore, these existing methods generally offer limited capacity for adaptability and scalability within diverse medical environments, making them impractical for wider adoption.

What is needed is a system that facilitates the withdrawal of medication from vials without necessitating an assistant to hold the vial, thereby reducing labor costs and minimizing the risk of needle stick injuries. The improvement of operational efficiency during medical procedures by providing a secure, adaptable, and easy-to-use vial holder could substantially enhance both safety and effectiveness in medical settings.

### FIELD

The present technology is within the field of devices for use in a medical setting, specifically relating to vial holders utilized in surgical and other medical settings to enable the autonomous withdrawal of medication from vials, thereby enhancing process efficiency and minimizing handling risks. The technology involves structural components for securely holding vials, featuring mechanisms such as a spring assembly and support structures for stability and ease of operation.

### SUMMARY

In one aspect, the technology disclosed relates to a vial holder configured for use in medical environments, such as surgical operations, to allow for the efficient withdrawal of medication from vials without necessitating the physical presence of an assistant to hold the vial. The vial holder comprises multiple components that collaborate to provide a stable and secure structure for supporting one or more vials simultaneously.

One object of the present technology is to improve operational efficiency in medical facilities by reducing the need for additional personnel during procedures involving vial-held medications. This is achieved through a design that enables independent vial management, thereby minimizing procedural disruptions and enhancing workflow.

In an embodiment, the vial holder includes a support or wall panel designed for secure mounting to a vertical support surface through predetermined recesses, providing a stable base for further components. The handle, which permits the actuation of a spring assembly, enables smooth transition between open and closed states, facilitating the secure insertion and removal of vials.

In another aspect, the spring assembly is engineered to offer controlled and reliable vial retention. This component arrangement is intended to significantly reduce manual handling, thereby mitigating potential hazards such as needle stick injuries, which are common concerns when vials are manually held by medical staff.

Yet another object of the vial holder is to enhance the safety and reliability of medical procedures by ensuring that vials remain securely in place within the holder's designated recesses. This design feature addresses common inefficiencies and risks associated with current vial handling practices, thereby providing an advantage in maintaining procedural sterility and safety.

In a further embodiment, the components of the vial holder are fabricated from durable materials, primarily plastic, with certain parts such as springs being constructed from metal to provide necessary flexibility and resilience. The assembly's material composition aims to balance durability with ease of maintenance, ensuring compatibility with standard medical sanitation processes.

Overall, the technology presented contributes to a more efficient, safer, and streamlined method of handling medication vials in medical settings, ultimately supporting improved healthcare delivery.

### BRIEF DESCRIPTION OF THE DRAWINGS

FIG. 1 is an exploded view of a vial holder assembly comprising components such as a vial holder, medicine tray, support rod, and support assembly.

FIG. 2 is a front view illustrating various components of the vial holder including a support rod, vial, handle, handle knob, and support panel.

FIG. 3 is an exploded view illustrating the arrangement of components such as the support rod, handle, handle knob, hex nut, spring panel, support panel, and screw.

FIG. 4 is a perspective view of an assembly with labeled components including a support rod, support, knob, vial, handle, handle knob, spring panel, support panel, and screw.

FIG. 5 is an exploded view of a vial holder assembly, illustrating components such as the vial, handle, rod, and various panels.

FIG. 6 is a perspective view illustrating the relationship between a medicine tray, a vial, and a support assembly.

FIG. 7 is an exploded view showing various components including a support rod, support, knob, handle, handle recess, handle knob, hex nut, support panel, screw, and support panel recess.

FIG. 8 is a cross-sectional view illustrating components of a vial holder assembly, including the handle, rods, and spring panel.

### DETAILED DESCRIPTION

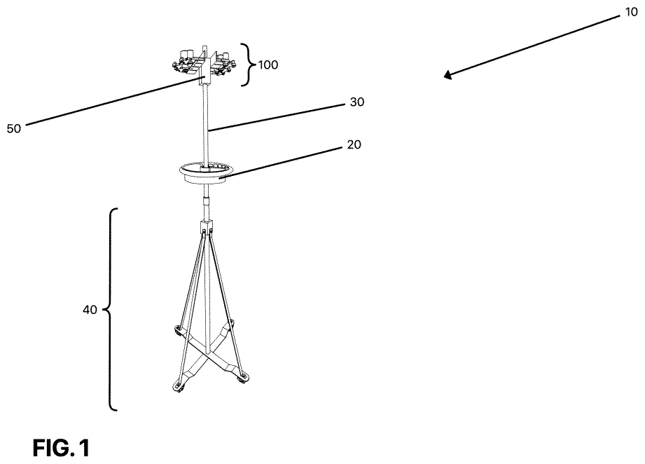

FIG. 1 shows the vial holder assembly 100, which is designed to facilitate the efficient withdrawal of medication from vials. The figure depicts the primary components comprising this assembly, including the vial holder 10, which securely holds multiple vials in place.

The vial holder 10 is supported by the support rod 30, which extends vertically and connects to the support assembly 40 at the base. The support assembly 40 provides a stable foundation, ensuring the efficacy and safety of the medical apparatus during usage. Additionally, the vial holder assembly support 50 is positioned midway along the support rod 30, offering additional structural integrity and balance to the apparatus.

The support assembly 40 is a structural component integral to the functionality and stability of the vial holder. It is configured to provide a stable foundation for the entire assembly, ensuring that the equipment can maintain a secure and steady position during medical procedures.

The support assembly 40 consists of a vertical member that engages with the vial holder assembly support 50 and interacts with the support rod 30. The support rod is an integral part of the support assembly 40, providing vertical alignment and stabilization for the holder and associated components. The assembly includes cross-sectional elements designed to enhance the mechanical integrity and balance of the structure, thereby reducing the risk of tipping or unintended movement during usage.

In certain configurations, the support assembly 40 may incorporate mobility features, such as wheels, to facilitate repositioning and transportation of the device within a medical setting. This mobility allows for adaptable placement and positioning, catering to different spatial and procedural requirements during use. The stability provided by the support assembly 40 contributes to minimizing operational disruptions and ensuring safe, repetitive use of the vial holder during clinical operations.

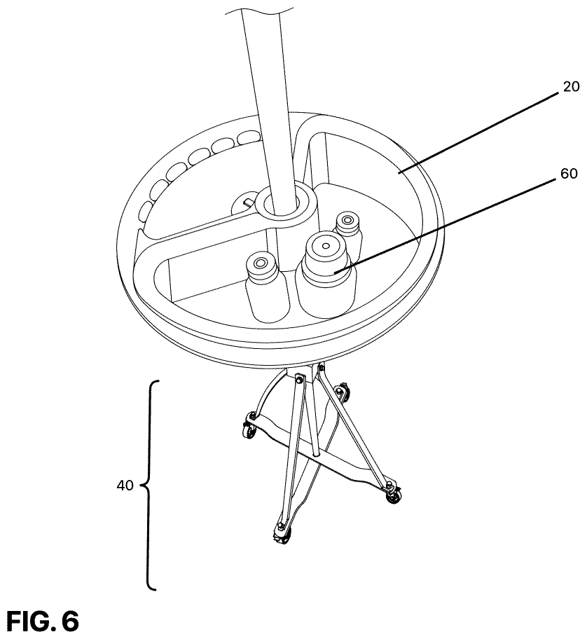

Positioned near the top of the support rod 30 is the medicine tray 20, designed to accommodate various medical instruments or vials. This configuration allows for easy access and organization of medical supplies during procedures. As best shown in FIG. 6, which shows a perspective view of a vial holder system prominently featuring a medicine tray 20, support assembly 40, and vial 60. The medicine tray 20 is shown attached to the upper portion of the support assembly 40 and includes sections designed for organizing and supporting medical supplies. The support rod 30 within the support assembly 40 is configured to allow for vertical adjustments of the medicine tray 20, enabling the tray to be moved up or down along the support rod. This adjustable feature provides flexibility in positioning the tray at the desired height in a medical environment, thereby accommodating different procedural or user requirements. The wheels at the base of the support assembly 40 facilitate easy transportation and repositioning of the medicine tray 20, optimizing mobility and accessibility during medical procedures.

Each component of FIG. 1 is integral to the overall structure and functionality of the device, illustrating a design that enhances procedural efficiency and minimizes risks associated with manual vial handling.

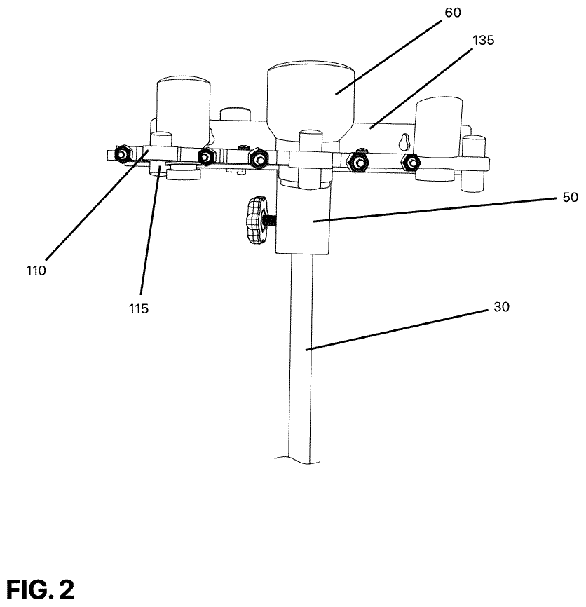

FIG. 2 shows a vial holder assembly 100 designed to securely accommodate multiple vials 60, depicted in conjunction with several supporting components. The support rod 30 provides vertical alignment and stability for the entire assembly. Connected to the support rod 30 is a vial holder assembly support 50, which serves as the main structural element securing the position of the vials 60.

The handle 110 is affixed to one side of the assembly, facilitating manual operation. Attached to the handle 110 is a handle knob 115, which allows for grip and manipulation by the user, thereby permitting adjustments or movements needed to align or secure the vials 60 as desired.

A support panel 135 extends beneath the vials 60, providing an additional layer of stability and support to ensure that the vials remain in a fixed and secure position during use. This configuration allows for efficient handling and extraction of contents from the vials without necessitating manual support from medical personnel, enhancing operational efficiency and safety during procedures.

The support panel 135, configured as an L-shaped support panel, provides enhanced structural stability and support to the vial holder assembly. This L-shaped configuration consists of a perpendicular arrangement of two panels, forming an angle that supports multiple orientations, facilitating both horizontal and vertical support. One panel of the L-shape lies horizontal to the support surface, while the other extends vertically, reinforcing the connection between the handle 110 and the support rod 30. This geometry optimizes the distribution of forces throughout the assembly, particularly during the operation of the handle, by distributing the tension exerted by the spring assembly. The L-shape also aids in aligning the assembly efficiently, contributing to the overall ergonomic design, which allows for secure handling and minimizes the risk of movement or displacement during use.

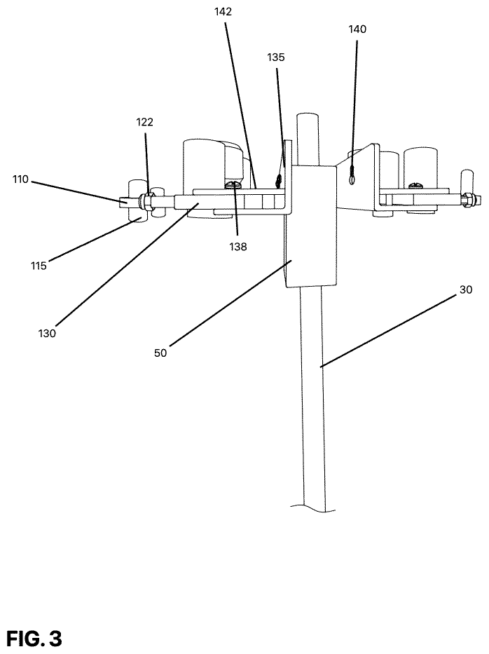

FIG. 3 shows a detailed schematic of the vial holder assembly 100, highlighting various structural and functional components integral to its operation within a medical setting. The assembly is mounted on a support rod 30, which provides vertical stability and secures the entire structure in place. The support rod 30 is connected to the vial holder assembly support 50, which serves as a base for the other components.

Attached to the vial holder assembly support 50 is the handle 110, which facilitates user interaction and is further equipped with a handle knob 115 to enhance grip during operation. The handle 110 is secured in place with a hex nut 122, ensuring stability and ease of manipulation. Positioned adjacent to the handle 110 is the spring panel 130, which is crucial for the tension mechanism that facilitates the opening and closing of the vial holder.

The assembly includes a support panel 135 that acts in conjunction with the spring panel 130 and is affixed using a screw 138. The screw 138 provides a reliable means of attachment, maintaining alignment and structural integrity. The support panel recess 140 is designed to accommodate alternative configurations for connecting the support panel 135 to vial holder assembly support 50, allowing for adjustments and movement as needed during operation. It is noted that in other embodiments, support panel 135 may be connected to a wall rather than a vial holder assembly support 50. While this embodiment it less mobile, it may be suitable in some medical settings.

Centrally located within the assembly is the top panel 142, which offers additional support and alignment for the attached components. Each element in FIG. 3 works coherently to ensure the efficient and safe handling of vials, minimizing the risk of manual mishandling during medical procedures.

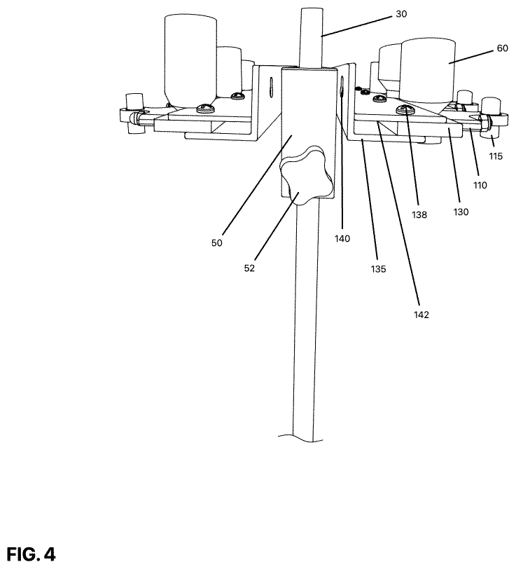

FIG. 4 shows a detailed perspective of the vial holder system, illustrating the arrangement and interaction of its components. The support rod 30 serves as the central upright element providing structural integrity and alignment for the various components. Attached to the support rod 30 is the vial holder assembly support 50, which secures the overall structure in place and ensures stability during operation.

The vial holder assembly support 50 incorporates a knob 52, which facilitates the adjustable positioning of the assembly relative to the support rod 30. This enables customizable height settings, essential for accommodating varied medical setups. Mounted above the assembly support 50 are vial holders, each holding a vial 60 securely in place. This setup ensures accessibility for medication withdrawal without manual intervention.

Two handles, identified as handle 110 and associated handle knob 115, are depicted as elements providing manual control. These components enable the user to manipulate the positioning of the vials or adjust their orientation as needed. The handle knob 115 enhances grip and ease of control during operation, ensuring a user-friendly interface.

Further detailed is the spring panel 130, which integrates with the assembly to apply necessary tension for holding vials in place. The support panel 135 offers additional stability and support, creating a robust framework. Aligning with this component is the support panel recess 140, which accommodates the positioning of the support panel 135. The connection is reinforced by screws 138, ensuring structural continuity and security.

A top panel 142 is observed, positioned parallel to other components. This panel aids in keeping the vials in a secure vertical alignment and serves as an additional protective cover for the assembly. The described configuration enhances the functionality of the vial holder 10, allowing healthcare professionals to operate efficiently in a medical setting.

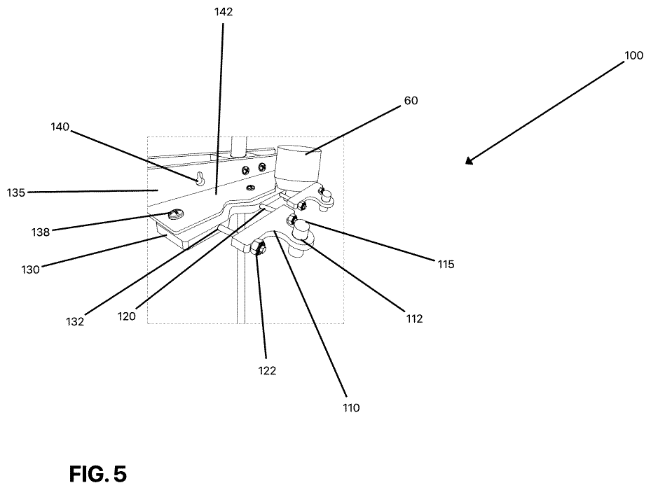

FIG. 5 shows the vial holder assembly 100, which is designed to facilitate the secure handling of a vial 60. The assembly comprises a handle 110 that includes a handle recess 112 and is equipped with a handle knob 115 for manual operation. The handle 110 enables the user to manipulate the vial holder assembly 100 effectively.

A rod 120 is positioned within the assembly, with a hex nut 122 securing it in place, ensuring structural integrity and allowing smooth operation. Adjacent to the rod 120 is the spring panel 130, which facilitates the necessary tension and movement to accommodate the vial 60. The rod recess 132 is incorporated into the spring panel 130 to guide and stabilize the rod 120.

In some embodiments, there is a rod 120 on both sides of the handle 110 thereby accommodating room for vial 60 to be between both rods 120.

The design further includes a support panel 135, which provides foundational stability to the assembly. The support panel 135 is connected via a screw 138, which adds to the robustness of the structure. A support panel recess 140 is present to accommodate any necessary adjustments or components within the assembly, facilitating ease of maintenance and adaptability.

At the top of the assembly, a top panel 142 is included, providing an upper boundary for the vial holder assembly 100 and contributing to the secure enclosure of the vial 60. This configuration is intended to streamline the process of medication withdrawal from the vial in medical settings, reducing the need for manual handling and enhancing operational safety and efficiency.

FIG. 6 shows a perspective view of a vial holder system prominently featuring a medicine tray 20, support assembly 40, and vial 60. The medicine tray 20 is depicted as a circular platform with sections designed for organizing and supporting medical supplies. The tray 20 is attached to the upper portion of the support assembly 40, which provides structural stability and facilitates movement and positioning of the tray in a medical environment.

The support assembly 40 is comprised of vertical and cross-sectional components, providing a robust framework. This assembly includes wheels at its base, allowing for easy transportation and adjustment of the tray's position as required during procedures. The integration with wheels suggests a configuration optimized for mobility and flexible positioning based on procedural needs.

Located on the medicine tray 20, the vial 60 is shown secured within a designated opening or compartment. This configuration allows for easy access to the vial contents while maintaining the vial's stability. The arrangement depicted ensures that multiple vials can be positioned securely on the tray, facilitating efficient access during medical procedures and reducing the necessity for manual handling. The design and arrangement may vary to accommodate different vial sizes or additional medical items within the tray's compartments.

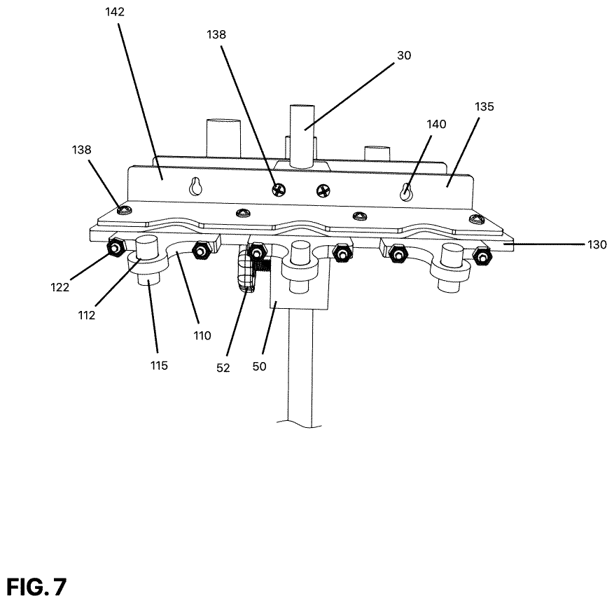

FIG. 7 shows the structural framework of a vial holder assembly, particularly highlighting the arrangement and interaction of its components. The support rod 30 extends vertically and forms the primary structural element to which other components are secured. The vial holder assembly support 50 is positioned below the support rod 30, facilitating stability and integration of other elements.

The handle 110 is depicted as ergonomically designed, with a handle recess 112 which is capable of receiving handle knob 115 for ease of grip. In particular, adjacent to the handle 110 is the handle knob 115, which serves as an auxiliary control element, allowing for precise manipulation of the assembly. The setup is further secured with a hex nut 122, which affixes the handle components to the underlying structure.

A spring panel 130 is situated horizontally above the handle, providing tension and flexibility during operation. The support panel 135, adjacent to the spring panel 130, enhances structural integrity and assists in aligning the assembly. A support panel recess 140 within the support panel 135 accommodates variable configurations, allowing for modular adjustments.

Fastening elements such as the screws 138 are utilized to secure the top panel 142, which serves as the uppermost boundary of the assembly. The top panel 142 acts as a protective cover that integrates with other structural components, ensuring durability and cohesion. The knob 52 is included within the design to provide manual control over the assembly's adjustments, enhancing usability.

Overall, FIG. 7 illustrates a well-coordinated assembly, emphasizing modularity and structural stability, essential for efficient operation within medical environments.

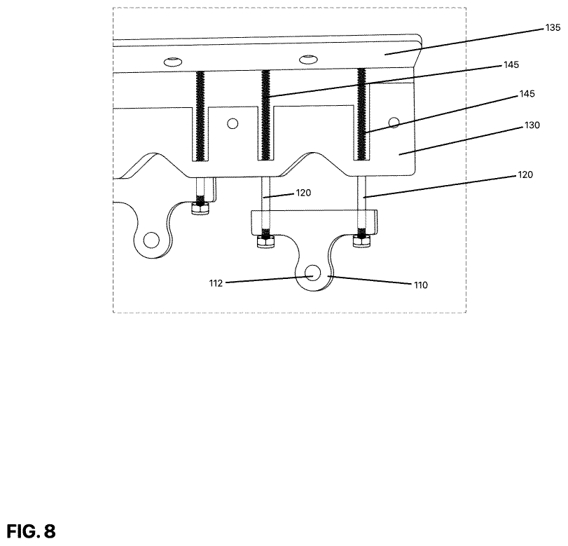

FIG. 8 shows a detailed section of the vial holder assembly, highlighting the structural arrangement and interaction of various components. The handle 110 is depicted at the lower part of the figure, indicating its role as a manual actuator. Adjacent to the handle 110 is the handle recess 112, designed to facilitate manual operation by providing a secure grip area.

Two rods 120 extend from the handle 110, acting as dynamic connectors between the handle and other components, thereby facilitating movement of the handle to pull it away from spring panel 130, thereby allowing a vial 60 to be inserted between handle 110 and a curve of spring panel 130. These rods 120 are shown passing through the central section, interfacing with the surrounding structure to transmit mechanical motion.

Having recesses for the rods 120, the spring panel 130 is illustrated as a horizontal element. The spring panel 130 interacts with two springs 145, which provide tension essential for returning the system to a desired position after operation. Springs 145 allow for controlled compression and expansion, ensuring consistent operation of the assembly components. These springs 145 are shown positioned coiling around the rods 120. The support panel 135, located at the uppermost section, provides structural integrity.

The figure effectively illustrates the integration of the handle 110, handle recess 112, rods 120, spring panel 130, support panel 135, and springs 145, detailing their cooperative function within the vial holder system. These elements are configured to enable smooth operation and maintenance of structural stability during their use in medical settings.

It will be appreciated by those skilled in the art that while the vial holder has been described in detail herein, the invention is not necessarily so limited and other examples, embodiments, uses, modifications, and departures from the embodiments, examples, uses, and modifications may be made without departing from the process and all such embodiments are intended to be within the scope and spirit of the appended claims.

1. A vial holder comprising:
a. a wall panel configured to be secured to a vertical surface, the wall panel including one or more recesses for receiving fasteners,
b. a vial receiving section designed to accommodate at least one vial,
c. a spring assembly comprising:
i. at least two rods threaded through a handle and operably connected to a support bar,
ii. a plurality of springs providing tension to the rods,
iii. a support bar movable between an open and a closed position by the operation of the handle, and
d. a bottom panel including a vial recess to secure the at least one vial in a stable position during use.

2. The vial holder of claim 1, further comprising a handle including recesses to facilitate manual operation, the handle configured to activate the spring assembly by being pulled to transition the support bar between the open and closed positions.

3. The vial holder of claim 2, wherein the spring assembly includes two first rods and two second rods, each rod having a rod cover to maintain the rod in its designated position.

4. The vial holder of claim 3, wherein the spring assembly further comprises a centrally positioned third rod to guide horizontal movement of the support bar.

5. The vial holder of claim 1, wherein the bottom panel comprises a first bottom panel portion and a second bottom panel portion, each configured to be attached to a support surface using screws.

6. A method for securing and dispensing medication vials during medical procedures, comprising:
a. securing a wall panel of a vial holder to a vertical surface, the vial holder having a bottom panel with a vial recess,
b. placing at least one vial into the vial recess,
c. operating a handle to transition a support bar between an open and a closed position via a spring assembly that includes multiple rods and springs, and
d. retaining the at least one vial securely in the vial recess during dispensing.

7. The method of claim 6, further comprising adjusting the position of the vial holder along the vertical surface to facilitate access during a procedure.

8. The method of claim 6, wherein the spring assembly includes first and second rods threaded through the handle and rod covers to maintain the rods in position.

9. The method of claim 6, wherein the spring assembly further comprises a third rod centrally positioned to guide horizontal transition of the support bar.

10. The method of claim 6, wherein the bottom panel is divided into first and second portions secured to a support surface using screws to enhance stability of the vial holder.

11. A vial holder assembly comprising:
a. a horizontal panel shaped to be capable of receiving a vial and having at least two recesses at either end;
b. the at least two recesses each containing a spring and a rod, wherein the spring is coiled around the rod; and,
c. at least one handle connected to the rods on either end of the at least one handle.

12. The vial holder assembly of claim 11, wherein the at least one handle also includes a recess, a recess and a knob, or a knob.

13. The vial holder assembly of claim 11, wherein the rods are threaded through recesses define in the at least one handle and secured with a hex nut.

14. The vial holder assembly of claim 11, wherein the horizontal panel is supported by a support panel.

15. The vial holder assembly of claim 14, wherein the support panel is configured as an L-shape with a bottom portion that is horizontal and sits below the horizontal panel and wherein there is a vertical portion that is configured to connect to a wall or support.

16. The vial holder assembly of claim 15, wherein the support panel is configured as one piece.

17. The vial holder assembly of claim 16, wherein there is a top panel on the top of spring panel.
